(19) United States
(12) Patent Application Publication
(10) Pub. No.: US 2009/0202974 A1
(43) Pub. Date: Aug. 13, 2009

(54) EDUCATIONAL BATHROOM PLAY STATION

(76) Inventors: Adam Sohn, Gaithersburg, MD (US); Anat Sohn, Gaithersburg, MD (US)

Correspondence Address: ROTHWELL, FIGG, ERNST & MANBECK, P.C., 1425 K STREET, N.W., SUITE 800, WASHINGTON, DC, 20005, US

(21) Appl. No.: 12/368,582

(22) Filed: Feb. 10, 2009

Related U.S. Application Data
(60) Provisional application No. 61/074,512, filed on Jun. 20, 2008.
(60) Provisional application No. 61/050,807, filed on May 6, 2008.
(60) Provisional application No. 61/027,548, filed on Feb. 11, 2008.

(51) Int. Cl. G09B 25/00

(52) U.S. Cl. 434/382

(57) ABSTRACT

An educational bathroom play station for teaching bathroom hygiene to children includes a bathroom vanity ergonomically adapted for use by a child and having a base unit with a sink, a top unit above the base unit, and a plurality of designated spaces for toiletry items. A plurality of buttons displaying icons representative toiletry items and bathroom activities are disposed on the play station and connected to a plurality of item- and fixture-identifying light sources disposed adjacent the designated spaces, the buttons and light sources being part of a cueing circuit responsive to operation of at least one of the buttons to cause at least one of the light sources adjacent a toiletry item to emit light guiding a user to the toiletry item in response to operation of one of the plurality of buttons displaying an icon corresponding to the toiletry item.

### CROSS-REFERENCE TO RELATED APPLICATIONS

This application claims priority from U.S. Provisional Patent Application No. 61/074,512, filed on Jun. 20, 2008, U.S. Provisional Patent Application No. 61/050,807, filed on May 6, 2008, and U.S. Provisional Patent Application No. 61/027,548, filed on Feb. 11, 2008, the disclosures of which are incorporated herein in their entirety.

### BACKGROUND OF THE INVENTION

I. Field of the Invention

The present invention relates generally to educational tools for children and, more particularly, to an educational bathroom play station that teaches children proper hygiene and encourages conservation through pretend play using simulated toiletry items and a variety of interactive sensory cues.

II. Discussion of the Background Art

Adults have long struggled to teach young children bathroom skills conducive to proper hygiene. The inventors have discovered that one of the reasons adults struggle in their attempt to teach children proper hygiene is the lack of suitable educational tools. Children enjoy and are motivated to engage in activities that are realistic, amusing, and fun. They particularly enjoy imitating adults engaged in various activities encountered in everyday household life. And while there are many toys that simulate ordinary kitchen environments, there is currently no toy to offer the broad range of activities that center around the bathroom.

Attempts by adults to teach good hygiene using existing bathroom fixtures are often ineffective because the small size of most children relative to adult-size bathroom fixtures makes it difficult for the children to wash their hands, brush their teeth, and perform other activities without the assistance of an adult to lift the child over the fixture and retrieve toiletry objects from shelves located outside the child's reach. This situation discourages the child from attempting to independently engage in these types of activities, creating frustration on the part of the child and their parents, and increasing the amount of time it takes for the child to adopt habits conducive to good hygiene.

In addition, bathroom activities frequently involve use of multiple toiletry items and fixtures in a sequence of steps that young children may find difficult to master and remember without adult supervision. However, adults cannot always be present when teaching opportunities are available to children. Many bathroom activities also involve water which, if used by a child without supervision, can lead to flooding, slippery floors and waste of valuable water resources. Another problem associated with unsupervised use of adult bathroom fixtures is the possibility of children being scalded by water that is too hot.

### SUMMARY OF THE INVENTION

The present invention overcomes disadvantages of the prior art by providing a toy bathroom play station with features that teach children bathroom skills necessary for maintaining proper hygiene. In particular, the bathroom play station encourages children to adopt personal hygiene practices such as washing their hands, brushing their teeth, combing their hair, and the like, by creating an inviting, accessible, and yet realistic bathroom environment with various simulated and/or actual toiletry items and fixtures. The bathroom play station also teaches children to locate the various bathroom fixtures and toiletry items in correct sequence for performing bathroom activities necessary to maintain proper hygiene.

In addition to teaching good hygiene habits, the play station may also incorporate pretend play aspects that allow children to understand the importance of conservation, thus creating a toy that establishes social and environmentally sound habits for the next generation at an unprecedented, early age.

An aspect of the invention is a bathroom play station or vanity designed to teach bathroom skills that promote good hygiene. The bathroom play station includes a lower base unit or vanity and an upper unit or vanity disposed on the base unit and ergonomically adapted for use by a child. Preferably, the bathroom play station includes a plurality of designated spaces for toiletry items defined on at least one of the base unit and the top unit.

In an embodiment, the bathroom play station includes a plurality of simulated and/or authentic toiletry items removably disposed in the designated spaces. Preferably, the bathroom play station includes a plurality of buttons displaying icons that represent one of the plurality of toiletry items disposed on the bathroom vanity or bathroom activities involving use of one or more toiletry items and/or bathroom fixtures.

In an embodiment, a plurality of item-identifying light sources are disposed adjacent the designated spaces, and a cueing circuit responsive to operation of at least one of the plurality of buttons is configured to cause at least one of the plurality of item-identifying light sources adjacent a toiletry item to provide a visual cue guiding a user to the toiletry item in response to operation of one of the plurality of buttons displaying an icon corresponding to the toiletry item. In an embodiment, the cueing circuit is configured to provide an audio cue, alone or in combination with a visual cue, in response to operation of one of the buttons.

The bathroom play station includes a plurality of bathroom fixtures including, but not limited to, a sink, a faucet with water control handles, a weight scale, a height measuring device, a towel rack, cabinet doors and drawers, and a clothing hook. In an embodiment, fixture-identifying light sources are disposed adjacent the bathroom fixtures, and the cueing circuit is responsive to operation of at least one of the plurality of buttons to cause at least one of the plurality of fixture-identifying light sources adjacent a fixture to provide a visual cue guiding a user to the fixture in response to operation of one of the plurality of buttons displaying an icon corresponding to the fixture. In an embodiment, the cueing circuit is configured to provide an audio cue, alone or in combination with a visual cue, in response to operation of one of the buttons.

Another aspect of the invention is an educational bathroom play station for teaching bathroom hygiene to children including a bathroom vanity ergonomically adapted for use by a child, the bathroom vanity including a base unit with a sink and a top unit disposed on the base unit; at least one bathroom fixture associated with one of the base unit and the top unit; a plurality of removable simulated toiletry items disposed on at least one of the base unit and the top unit; a plurality of buttons disposed on the bathroom vanity, at least some of the buttons displaying an icon representative of one of a bathroom activity involving one of the plurality of toiletry items and one of the plurality of toiletry items; one or more item-identifying lights associated with at least one of the bathroom fixture and one of the toiletry items; and a circuit responsive to operation of at least one of the plurality of buttons to cause the one or more indicators to provide at least one of an audible and a visual cue guiding a user to at least one of the bathroom fixture and the toiletry item in response to operation of one of the plurality of buttons.

Another aspect of the invention is a method of teaching hygiene to a child using a bathroom play station including a plurality of simulated or authentic toiletry items disposed in designated spaces in and/or on the play station, a plurality of buttons arranged on the play station at locations remote from the designated spaces and including icons which represent either individual toiletry items or bathroom activities involving the use of one or more toiletry items. The method include the steps of presenting to the child the bathroom play station and the plurality of buttons; receiving input when the child presses one of the plurality of buttons; activating an audible and/or a visual cue using a cueing circuit in response to the button press; guiding the child to begin using the designated toiletry item or to begin performing the designated bathroom activity; and providing the child with feedback on completion of the activity.

Another aspect of the invention is a method of teaching hygiene to a child using a bathroom play station, the method including the steps of presenting the child with a plurality of simulated toiletry items disposed in designated spaces in and/or on the play station, wherein the designated spaces are configured to accommodate authentic toiletry items and the simulated toiletry items are configured to be substantially the same shape and size as the authentic toiletry items; and replacing at least some of the simulated toiletry items with corresponding authentic toiletry items in the appropriate designated spaces.

Other features and advantages of the invention will become apparent to those of skill in the art upon reviewing the following detailed description of the preferred embodiments and the accompanying drawings.

### BRIEF DESCRIPTION OF THE DRAWINGS

The accompanying drawings, which are incorporated herein and form part of the specification, illustrate a preferred embodiment of the present invention and, together with the detailed description, further serve to explain the principles of the invention and to enable a person skilled in the art to make and use the invention. In the drawings, like reference numbers are used to indicate identical or functionally similar elements.

FIG. 1 is a perspective view showing the front and right side of a toy bathroom play station according to an embodiment of the present invention.

FIG. 2 is an elevational view showing the front of the toy bathroom play station of FIG. 1 with a central wall cabinet door in an open position and with removable toiletry items positioned at designated locations within the wall cabinet.

FIG. 3 is the same elevational view as FIG. 2 but with the toiletry items removed to show item icons on a back or rear of the wall cabinet.

FIG. 4 is an elevational view showing the left side of the toy bathroom play station of FIG. 1.

FIG. 5 is an elevational view showing the rear of the toy bathroom play station of FIG. 1.

FIGS. 6A, 6B, 6C, and 6D are flow charts showing a method of using a toy bathroom play station to teach bathroom hygiene according to an embodiment of the present invention.

FIG. 7 is a schematic diagram showing an electronic cueing circuit for a toy bathroom play station according to an embodiment of the present invention.

### DETAILED DESCRIPTION OF THE PREFERRED EMBODIMENTS

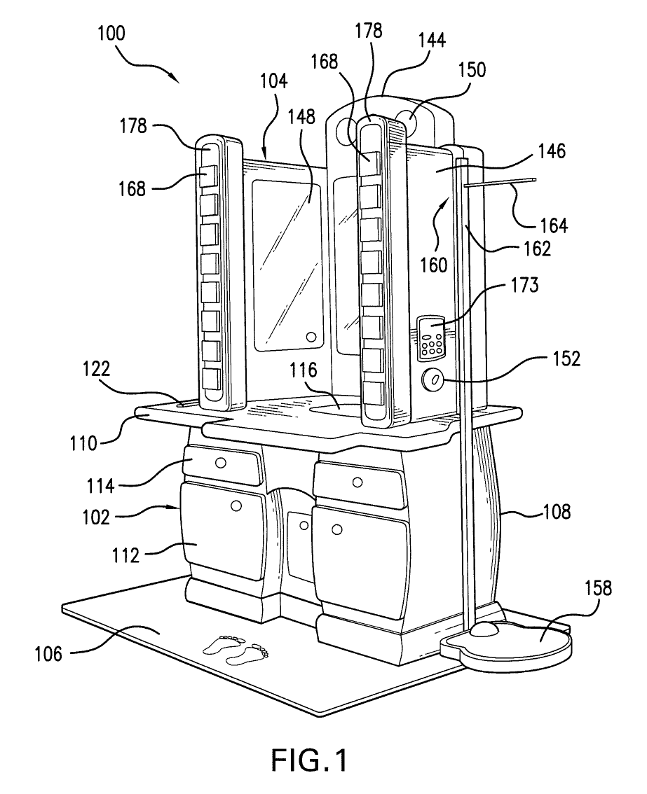

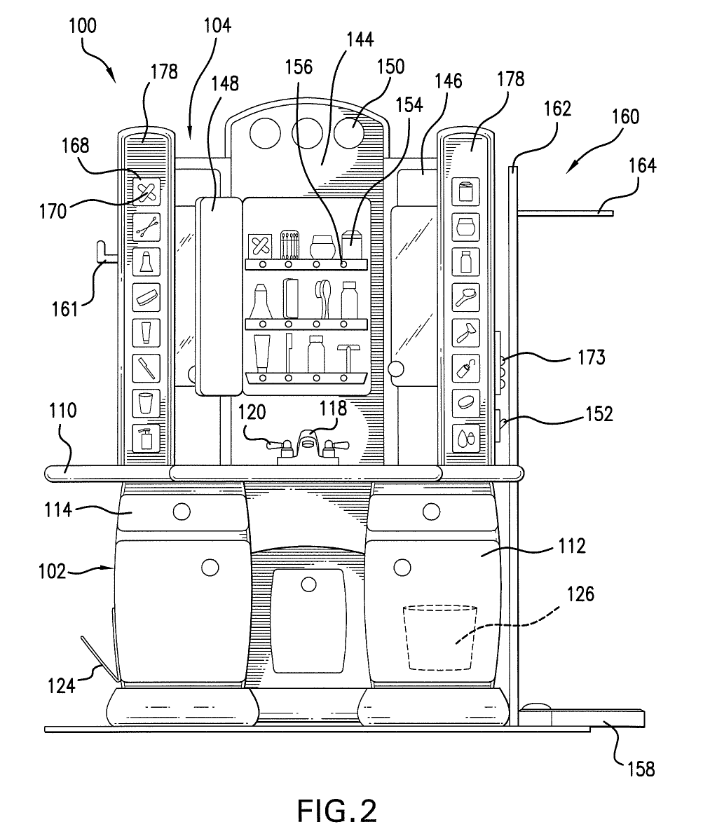

An educational bathroom play station 100 according to an embodiment of the present invention is shown in FIGS. 1-5. The play station 100 includes a base unit 102 and a top unit 104 disposed on top of the base unit. Together, the base and top units 102 and 104 create an integrated bathroom environment ergonomically adapted for use by a child. As described in greater detail below, a plurality of simulated and/or authentic toiletry items of the type used to perform bathroom activities are disposed in designated spaces on the base and/or top units. The play station 100 may also include a bath mat 106 for placement on the floor in front of the play station.

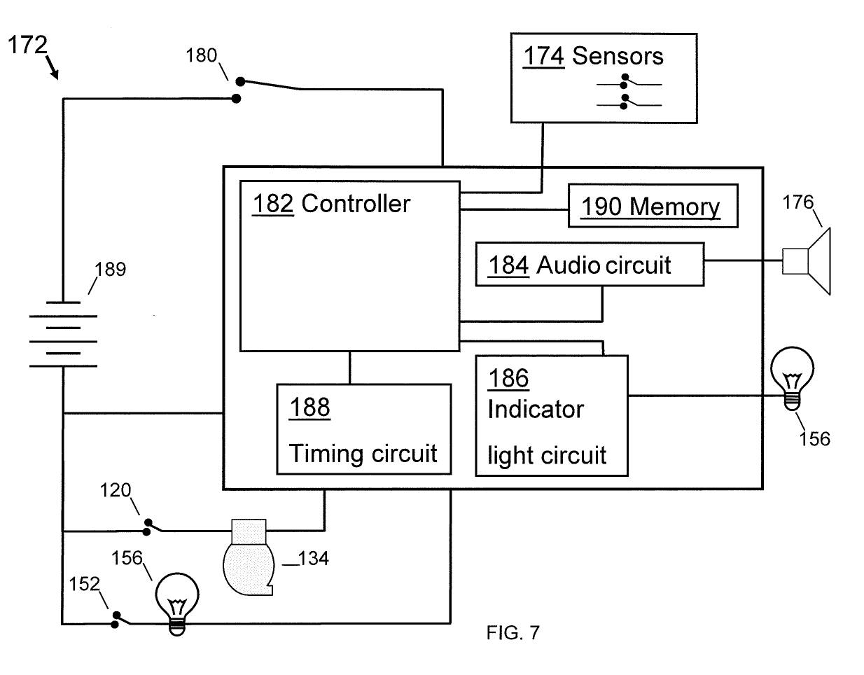

The base unit 102 includes a base cabinet 108 and a top 110 adapted to rest horizontally on top of the base cabinet. The base cabinet 108 includes a front, a back, and right and left sides defining an interior cabinet space. In an embodiment, the front of the base cabinet 108 includes one or more cabinet doors 112 and one or more drawers 114. In an embodiment, a sensor (element 174 in FIG. 7) is disposed proximate one or more of the doors 112 to detect when the door is opened or closed. The interior cabinet space may be used for storage of simulated or authentic toiletry items, and other items normally associated with a bathroom environment.

The vanity top 110 is adapted to form or receive a sink basin 116 spaced a suitable distance from a front edge of the cabinet top to be accessible to a child standing in front of the bathroom play station 100. The vanity top 110 defines a surface that is of suitable height for use by a child, e.g., low enough for a child to bend over when using the sink 116 or reaching for items near a rear edge of the vanity. A peripheral edge of the vanity top 110 preferably extends laterally outward from one or more edges of the base cabinet to increase useable surface area of the vanity. Peripheral edges of the vanity top are preferably rounded as shown to eliminate sharp edges that may injure a young child.

In an embodiment, the lower unit 102 includes near the sink 116 a faucet 118 with one or more faucet handles 120. The faucet 118 may be a simulated faucet for pretend play or a real faucet that is operable to dispense water from a water source as described in greater detail below. If the faucet 118 is a simulated faucet, operation of the handles 120 will not cause water to flow but may cause an audio cue to be generated. Examples of the types of audio cues that can be generated by the cueing system in response to operation of the faucet handles include, but are not limited to, educational messages about the faucet (e.g., identifying the fixture as a faucet and/or providing instructions for use, such as “Remember to turn off the water when you are done”), or the sound of running water. If the faucet 118 is operable, the handles 120 may be used to control the flow rate and temperature of water dispensed from the faucet. In an embodiment, a sensor (element 174 in FIG. 7) is disposed proximate each handle 120 to detect an operational state of the faucet. Alternatively, the handles 120 may directly operate an electrical switch which then controls the flow of water. In an embodiment, the electrical connection at the faucet, whether a switch directly in the faucet or a sensor adjacent the faucet, is monitored by a controller (element 182 in FIG. 7) described in more detail below. In addition to other possible uses, the controller and its associated timing circuit may be used to monitor water flow and to stop flow after a pre-determined period of time.

In an embodiment, a towel rack 122 is mounted or formed on one side of the bathroom play station 100. For example, the towel rack 122 may be defined by an elongate slot formed through the vanity top 110 along a side edge of the vanity top that protrudes laterally outward from the base cabinet. In an embodiment, a sensor (element 174 in FIG. 7) is disposed in proximity to the towel rack (e.g., in the slot) for determining whether a towel is present in the rack.

In an embodiment, the lower unit 102 includes a magazine rack 124 attached to the base cabinet 108. The magazine rack is preferably mounted on a side of the base cabinet 108 to provide a place for storing books, magazines, and other reading material of interest to a child.

In an embodiment, a tissue box (not shown) may be affixed to an exterior surface of the bathroom play station, e.g., on a front or side surface of the base cabinet 108, to dispense facial tissues. Alternatively, a bracket may be provided for holding commercially available tissue boxes that may be removed from the bracket and replaced.

In an embodiment, the interior of the lower unit 102 houses a waste basket 126. Preferably, the waste basket 126 is attached on an interior side of one of the base cabinet doors 112 to allow removal and dumping of the wastebasket when the door is opened. Preferably, the wastebasket 126 includes a lid and a sensor (element 174 in FIG. 7) mounted in proximity to the lid for determining when trash is deposited into the wastebasket.

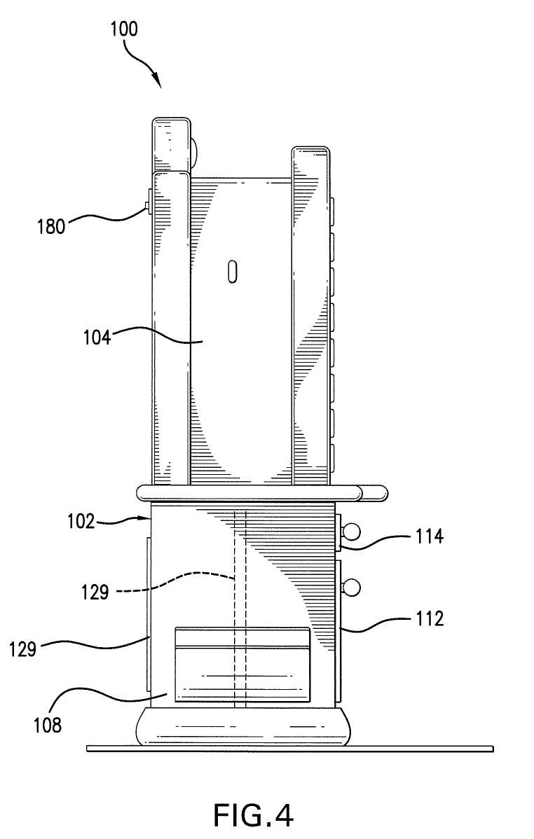

In an embodiment, best seen in FIG. 4, the interior cabinet space of the lower unit 102 is divided by a partition 128 into a front space, that is accessible to the child user via the one or more cabinet doors 112 on the front of the base cabinet, and a restricted rear space accessible only to adults via one or more access doors 129 on the rear of the base cabinet. Preferably, the rear access doors 129 can be locked to prevent children from accessing the restricted rear space in the cabinet.

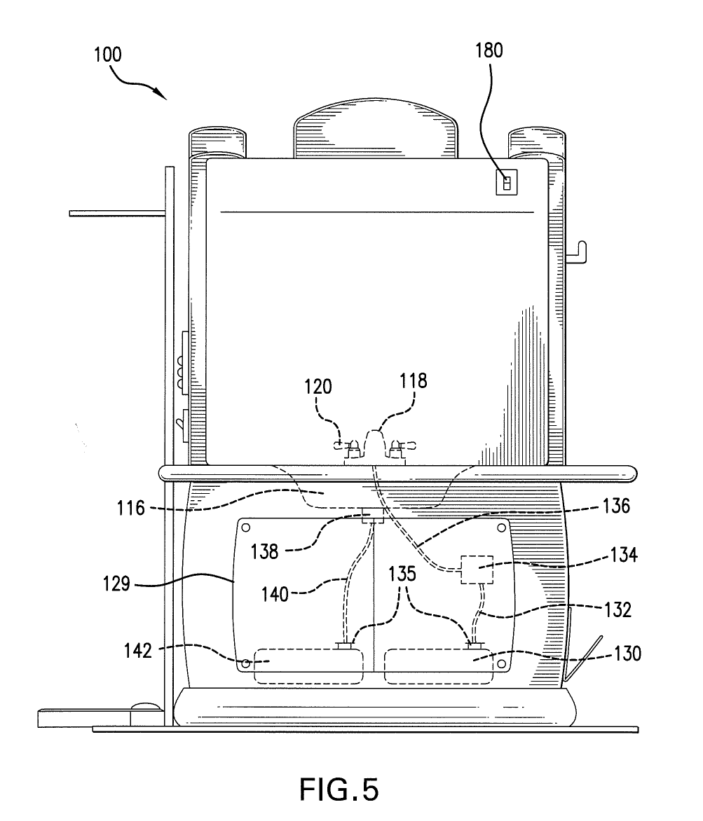

In an embodiment, best seen in FIG. 5, the interior rear section of the base cabinet 108 provides a space to house a clean water container 130, such as a gallon jug of water with integral handle. A first tube 132 extends from the water container 130 to a water pump 134 that creates suction to draw water out of the container when operated. The tube 132 extends into the container 130 such that a bottom end of the tube is disposed near a bottom of the container and a top end of the tube is connected to an inlet port of the pump 134. A cap or plug 135 is preferably positioned on the tube 132 to seal the opening at the top of container 130. The pump 134 is located in the flow path to draw water from the container 130 via the first tube 132 and to then expel the water through a second tube 136, out of the faucet 118, and into the sink 116. The sink 116 is adapted to form a drain 138 to which is attached a drain tube 140. The drain tube 140 is attached at one end to the sink drain 138 and has a lower end placed in or attached to the opening of a waste water container 142, such as an empty gallon jug with integral handle, to capture the waste water. A second cap or plug 135 is preferably positioned on the drain tube 140 to seal the opening at the top of container 142. If desired, feed tube 136 can be divided into two feeds, and one of the feeds can be heated to provide warm water when the child selects the hot water faucet handle.

The rear access doors 129 in the rear of the base cabinet may be moved between open and closed positions to allow for easy access to remove the waste container 142 or to replenish the fresh water supplied by replacing/refilling the water container 130.

The top unit 104 is disposed on top of the base unit 102 and includes a wall structure. The wall structure extends vertically upward from and perpendicular to the vanity top 110. The wall structure is defined by a center wall panel 144 substantially parallel to a rear edge of the vanity top 110 and by side wall panels 146, the front surfaces of which extend forwardly from opposite sides of the center panel at an obtuse angle relative to the plane of the center panel. Preferably, the front surfaces of the side panels 146 extend toward the front of the play station 100 at angles between about 120 and 150 degrees from the center panel, with 135 degrees being most preferred. As a result, the center panel 144 is front facing and the front surfaces of the side panels 146 are angled inwardly toward the child. This orientation of the side panels 146 makes them more easily viewed by and accessible to a child positioned in front of and facing the play station, and this is additionally useful if more than one child is using the play station.

Preferably, one or more wall cabinet doors 148 are mounted on a front surface of at least one of the center or side panels 144,146 to provide access to wall cabinet space defined within the walls of the top unit 104. The wall cabinet doors 148 are preferably mirrored to allow a child to view their progress as they perform bathroom activities. Alternatively, a fixed mirror may be mounted on the center panel 144, with one or more wall cabinets being mounted on one or both of the side panels 146. Preferably, the mirrored surfaces are formed of a shatterproof material that prevents a child from being injured in the event of an accidental impact.

Optionally, one or more vanity lights 150 are mounted on the center panel 144 above the wall cabinet door and controlled by a vanity light switch 152 mounted on the bathroom play station at a location accessible to a child standing in front of the play station.

The bathroom play station 100 preferably contains a variety of everyday bathroom or toiletry items 154 to teach children proper hygiene. Preferably, at least some of the items 154 are disposed inside one or more of the cabinets of the play station 100 in designated spaces to teach children the concept of finding items that are not laid out in plain view. Preferably, at least some of the items 154 inside the cabinets are disposed within small brackets or molded cavities to hold the items in their designated spaces within the cabinets. Preferably, an item-identifying light 156 is mounted adjacent each item 154 to be visible to a child standing in front of the play station when the door to the appropriate wall cabinet is open. Also, each space is preferably provided with a sensor (element 174 in FIG. 7) for determining whether or not an item is present in its designated space. An optional cueing system control circuit (described below) can be adapted to detect removal and insertion of items 154 using signals or data from the sensors.

In an embodiment, at least some of the bathroom items 154 are simulated bathroom items. The simulated bathroom items preferably resemble the corresponding actual bathroom items in size and shape so that they may later be replaced with real, commercially-available items when the child is ready. In this way, the real items should fit within the designated spaces within the cabinet in the same manner as the simulated items. Some examples of the types of simulated items that may be supplied include: toothpaste, adhesive bandages, mouthwash, vitamins, shaving cream, razor, razor brush, lotion, baby powder, deodorant, thermometer, and nail clippers. Simulated bathroom items may be combined with real bathroom items, such as a usable toothbrush, hair brush, comb, and cup for rinsing.

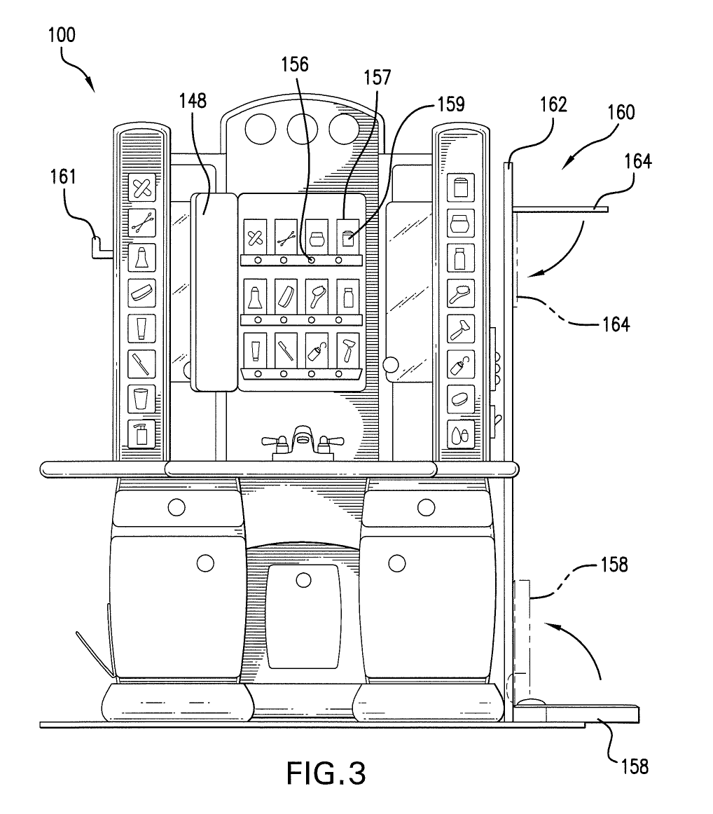

In FIG. 3, the center wall cabinet is shown with door 148 in an open position and the bathroom/toiletry items 154 removed to show the rear or back of the wall cabinet. A plurality of placards 157, each with an icon 159 representing a toiletry item 154, are mounted on the back wall above the designated spaces for the corresponding items. Preferably, the icons 159 within the wall cabinet are identical to icons on user interface buttons on the exterior of the unit. It should also be noted that, although the wall cabinets are shown with two shelves, the cabinets may have no shelves, one shelf, or two or more shelves, depending upon the space needed for storing items.

The bathroom play station 100 preferably also includes a clothing hook 161 mounted on a side panel of the top unit 104 to hold a bathrobe or towel, a movable toothbrush holder (not shown) which may be located within one of the wall cabinets or positioned within a receptacle formed in the vanity top adjacent the sink basin, a soap dish (not shown) positioned within a receptacle formed in the vanity top 110, and/or a soap dispenser (not shown) with a manual pump mechanism configured to sit on the vanity top.

In an embodiment, the bathroom play station also includes a weight scale 158 and height measure 160. The weight scale 158 and height measure 160 are preferably integrated into a unit that mounts against a side of the bathroom play station 100 as shown. Preferably, sensors on the weight scale 158 and height measure 160 provide an audible and/or visual function that activates a recording and/or lights when a child steps onto the weight scale 158 or places the sliding arm of the height measure 160 above his/her head. The height measure includes a vertical reference bar 162 and a horizontal height marker 164. The reference bar 162 is labeled with measurements of inches (and/or centimeters) referenced to zero at the top of the weight scale 158 and increasing in height upward to near the top of the play station, thus creating a growth chart. The height marker 164 is connected to and moveable along a track formed in or on the reference bar 162.

In an embodiment, the play station 100 further comprises a memory device (element 190 in FIG. 7) which is connected to the weight scale 158 and/or height measure 160, and which is used for storing information about at least one of a user's weight and height, and which includes a means for conveying this stored information to a user. In an embodiment, the means for conveying this stored information is through audio of recorded or computer generated voice using the play station's audio circuit which is described below.

The play station 100 preferably includes interactive sensory features that help teach a child to locate fixtures and toiletry items on the base and top units 102 and 104 of the play station. The interactive features include user interface panels 178 displaying a plurality of buttons 168 disposed on the play station 100 at locations within reach of a child standing in front of the play station.

Each of the buttons 168 preferably displays an icon 170 corresponding to one of the plurality of toiletry items 154 disposed on or in the play station 100 at various locations. The icons 170 preferably resemble the corresponding items 154 to facilitate easy association by a young child. Optionally, one or more of the buttons 168 may display an icon 170 depicting a bathroom activity such as washing hands, brushing teeth, combing hair, or the like. The buttons 168 are preferably connected to an electronic user interface or cueing circuit 172 that generates audible and/or visual cues in response to operation of one or more of the buttons. The audible and/or visual cues are used by the play station 100 to teach a child to identify and locate the various bathroom fixtures and toiletries that are used in everyday bathroom activities as well as to guide the child through the sequence of steps involved in such activities. The user interface 172 is described in more detail below.

In an embodiment, electronic components of the cueing system 172 are disposed within a housing 173. Preferably, the housing 173 is mounted on the top unit 104 of the play station. One or more knobs or buttons may be mounted on the housing 173 to control aspects of the cueing system such as language and volume of the audio cues. The housing 173 may also contain one or more speakers (element 176 in FIG. 7) to reproduce audio cues and a space for batteries if the play station is battery powered. Preferably, language options include a plurality of languages, such as English and Spanish, and these are selectable by operation of one of the panel knobs or switches. The housing 173 may also include a switch or knob for selecting different operating modes, e.g., for different times of the day (morning, bedtime, etc.), different ages or grade levels, and/or different levels of familiarity with the play station (introductory, advanced, etc.).

In an embodiment, user interface panels 178 extend vertically along the front edges of the top unit 104. A plurality of buttons 168 are disposed along the length of each vertical user interface panel 178. The buttons 168 are depicted as being square in shape and arranged in a linear fashion at equally spaced intervals along the length of each user interface panel 178. However, it will be appreciated that various other shapes may be used, including without limitation circular, elliptical, polygonal shapes other than squares, and combinations of the foregoing. In addition, the buttons 168 may be arranged in staggered columns, in circular or serpentine patterns and in various other configurations. Some or all of the buttons 178 may be positioned on other parts of the base and top units so long as they are within the view and reach of a child standing in front of the bathroom play station. Each button 168 includes an icon 170 depicting a toiletry item disposed in or on the bathroom play station or a bathroom activity that may be performed using the bathroom play station. In an embodiment, each button 168 also includes an internal light which illuminates or silhouettes the icon 170. Sixteen buttons 168 are shown by way of example, representing toiletry items such as a toothbrush, toothpaste, mouthwash, cup, razor, shaving cream, a bar of soap, a soap dispenser, antiperspirant, hairbrush, cotton swabs, bandages, comb, powder, dental floss and a jar of cream. However, it will be appreciated that other toiletry items may be depicted, as well as bathroom activities such as washing hands, washing face, brushing teeth, flossing, shaving, cleaning ears, removing makeup and disposing of trash. Preferably, the toiletry item icons resemble in appearance and shape the simulated items 154 provided with the bathroom play station in order to help the child associate cues with items. In an alternative embodiment, the buttons may be icons displayed on an electronic touch screen.

The bathroom play station guides children to toiletry items and bathroom fixtures using visual and/or audio cues. In an embodiment, visual cues are provided by item-identifying lights 156 located adjacent toiletry items 154 and/or fixture-identifying lights (not shown) located adjacent bathroom fixtures such as the doors, drawers, faucet, towel rack, magazine rack, and light switch. For example, in the case of doors 112, 148 and drawers 114, lights may be mounted on the door knobs and selectively activated to guide the child to a particular door or drawer on the bathroom play station, or the lights may be mounted directly on these fixtures, or on a cabinet adjacent the fixtures. In an embodiment, the lights form a border around one or more of the doors 112, 148 and/or drawers 114. Similarly, in the case of the faucet 118, lights may be mounted on the handles 120, on the vanity top 110 adjacent the handles or anywhere else in close proximity to the faucet. Preferably, lights are also mounted in proximity to the towel rack 122, the weight scale 158, the height measure 160, the vanity light switch 152, and the magazine rack 124.

In an embodiment, as space-saving and safety features, the connections of the weight scale 158 and height marker 160 to the play station may be hinged to allow them to rotate out of the way. This reduces the overall footprint of the play station and facilitates storage. (See broken lines in FIG. 3.)

Preferably, a master power switch 180 is located near the top, rear of the top unit 104. Being on the rear of the unit and at maximum height, the switch 180 is mainly accessible only to an adult. In the “ON” position, this switch allows the supply of electrical power from one or more batteries (not shown) or a wall outlet to all electric components of the play station (e.g., a water pump, lights, electronics, and audible components). In an embodiment, the child-operated vanity light switch 152 on the side of the unit in FIG. 1, receives power through the adult-operated switch 180, so that the lights and other powered components will not operate unless the adult-operated switch is in the “ON” position.

It will be appreciated that the structure of the play station is of reduced scale in comparison to full-size bathroom fixtures in order to enable young children standing in front of the play station to reach the sink and features mounted on the walls without adult assistance. For example, the vanity preferably has a width of about 26″ to about 44″, a depth of about 13″ to about 20″, an overall height of about 36″ to about 45″, and a counter height of about 19″ to about 25″.

The edges of most or all major features, including the top and base units, vanity top, doors, drawers, walls, front facing buttons and knobs, wall cabinets, and sink are preferably rounded, most preferably with a radius of curvature of at least half an inch, in order to present a child-friendly look and feel, and in order to reduce the likelihood of injury.

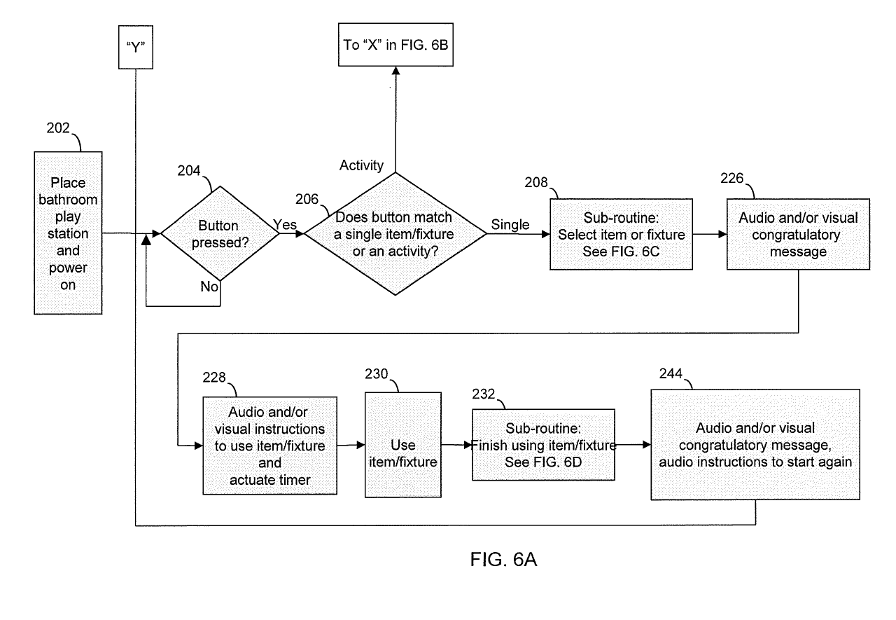

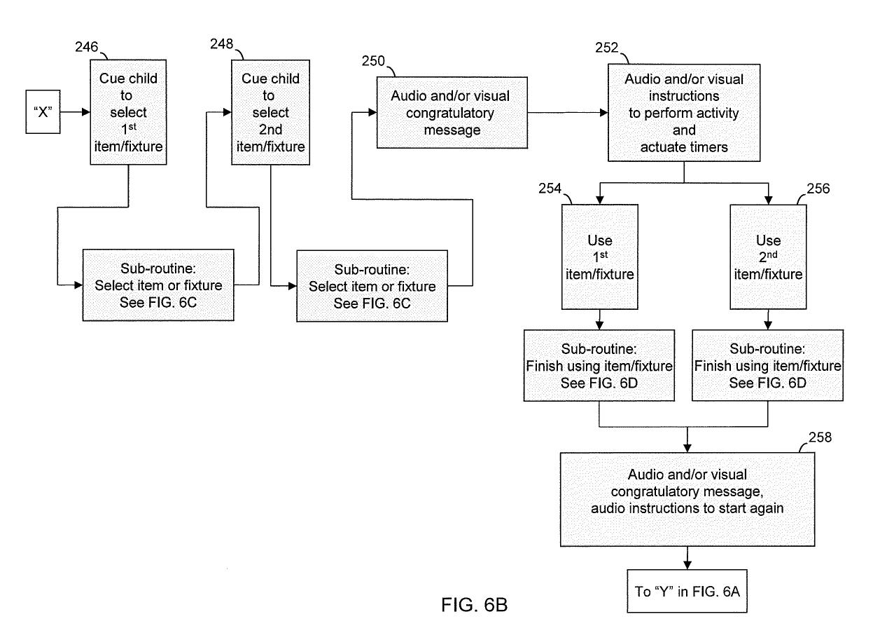

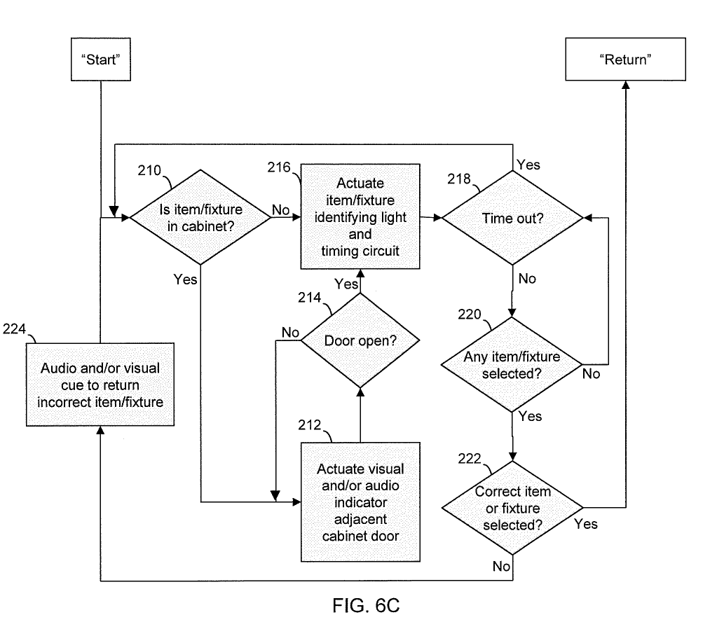

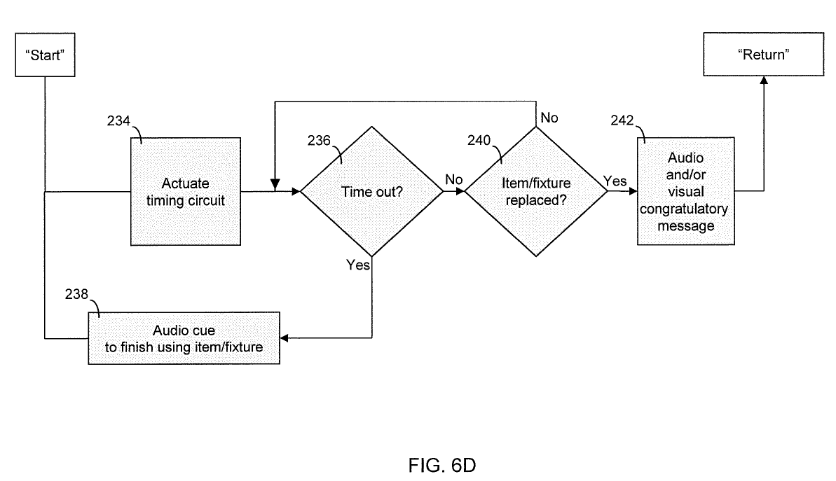

FIG. 6A is a flow chart showing a method of operation of a toy bathroom play station according to an embodiment of the present invention. In step 202, the bathroom play station is positioned at a location conducive to teaching bathroom hygiene. Since the play station is preferably a self-contained unit, it may be positioned in a variety of locations without loss of functionality. Preferably, the location helps to associate hygiene training with the bathroom, creating a child-specific area to learn and become comfortable with everyday bathroom hygiene activities, while not interfering with residential routine and traffic flow. A few places where the play station may be placed in the home are near a bathroom or a child potty seat, near the kitchen (to reinforce good hygiene before and after eating), and near an exterior door (to encourage hand washing when entering the home), as well as other areas of the home. The play station may also be placed in a school or day care setting.

In an embodiment, the play station is positioned with sufficient frontal clearance for a bath mat to be positioned on the floor in front of the bathroom play station. In a further embodiment, the bath mat includes a depiction of footprints to provide an indication where a child should stand to access features of the bathroom play station. In an embodiment, the bath mat is absorbent to control spills.

Once the bathroom play station is positioned and ready for use, an adult may put the play station into an operational state by use of the master power switch 162 on or near the top, rear of the play station. In the operational state, power is supplied to all of the electrical components of the invention, including the electronic circuit that controls the interactive features. With the master power switch in the “ON” position, power to the vanity lights may be controlled by a light switch located on or near the front of the unit within reach of a child standing in front of the play station.

In step 204, the play station waits for a child to push one of the buttons while standing in front of the unit. In an optional step (not shown), the play station uses a motion sensor or the like to determine whether a child is located in front of the unit and, when the presence of a child is detected, the play station generates an audio and/or visual cue, e.g., a greeting welcoming the child, providing instructions for use, or the like. Alternatively, the audio and/or visual cue may be triggered by operation of the vanity light switch 122. When the bathroom play station determines that a button has been pressed, it then determines in step 206 whether the selected button depicts a toiletry item/fixture or a bathroom activity. A bathroom activity may involve the use of one or more toiletry items and/or fixtures. If the button depicts a bathroom activity, the play station initiates the process shown in FIG. 6B and described below.

If the play station determines that the button depicts a single toiletry item or fixture, the play station then guides the user to select the item/fixture using audio and/or visual cues in step 208. The process or sub-routine for selecting an item/fixture is described below with reference to the flow chart shown in FIG. 6C.

In FIG. 6C, the sub-routine begins with step 210 where the play station determines if the selected item/fixture is contained within a cabinet. If yes, then in step 212 the play station provides visual and/or audio cues emanating from a location adjacent to the relevant cabinet door. In step 214 the play station senses whether the door has been opened. If the door has not been opened, step 212 repeats. If the door has been opened, the play station actuates an item/fixture identifying light adjacent the predetermined location of the item/fixture and actuates a timing circuit to measure a time period for retrieval of the item, at step 216. In step 218, the play station determines whether a predetermined time out period has elapsed without removal of an item from the play station or, in the case of a fixture, without handling or interacting with that fixture. Either removal of an item or handling of a fixture constitute selection of that item/fixture, and the play station makes this determination using sensors connected to or in proximity to each item/fixture. If time does run out before an item/fixture is selected, as determined by the associated sensor and the timing circuit, then the play station repeats step 210. In step 220, the play station checks whether any item/fixture has been selected. If not, the play station returns to step 218. If any item/fixture has been selected, then in step 222 the play station determines if the selected item/fixture is the correct item/fixture. If the selected item/fixture is incorrect, then in step 224 the play station provides audio and/or visual cues to return the incorrect item/fixture to its original condition and then returns to step 210. If the correct item/fixture is selected, then the sub-routine returns to the process shown in FIG. 6A where, in step 226, the play station generates an appropriate audio and/or visual cue (e.g., congratulating the user on selecting the correct item/fixture). Then in step 228, the play station generates audio and/or visual instructions to use the item/fixture. In step 230, the user begins using the item, and in step 232 the play station executes the sub-routine shown in FIG. 6D.

In FIG. 6D at step 234, the play station actuates the timing circuit to measure a time period for use of the item. In step 236, the play station determines if the time period has elapsed. If a time out occurs, the play station generates an audio cue to replace the item in step 238, and repeats steps 234 & 236. If no time out has occurred, then in step 240 the play station determines if the item/fixture has been returned to its original condition. The determination is made using a sensor associated with the item/fixture. If the item/fixture has not been returned, then the play station repeats step 236. If the item/fixture has been returned, then in step 242 the play station generates an audio and/or visual message congratulating the user on returning the item/fixture. The play station then exits the sub-routine and returns to the step following the step from which the sub-routine was called, in this instance, step 244 of FIG. 6A.

In step 244, the play station generates an audio and/or visual message congratulating the user on completing use of the item/fixture. The play station then repeats the interactive process by returning to step 204. The play station may generate audio and/or visual cues with suggestions for additional bathroom activities that may be performed, e.g., by multiple appropriate buttons in sequence and generating audio cues identifying the respective activities as buttons are illuminated.

Referring now to FIG. 6B, if the play station determines that the child has selected a button depicting a bathroom activity, it actuates a series of audio and/or visual cues that help the child locate the various items and/or fixtures of the play station in an appropriate sequence for performing the selected bathroom activity. In steps 246 and 248, the play station cues the child to select the items or fixtures related to the activity. Selection of an item or fixture again relies on the sub-routine shown in FIG. 6C.

Then back in step 250 of FIG. 6B, the play station congratulates the child on selecting the correct items and fixtures for the activity. Then in step 252, the play station provides instructions on how to perform the activity. Following or, optionally, simultaneous with completion of the instructions, the play station then monitors use of the selected items/fixtures, beginning with steps 254 and 256. Steps 254 and 256 both rely on independent instances of the sub-routine shown in FIG. 6D. When both have been returned, then in step 258 the play station plays a congratulatory message. The play station then repeats the interactive process by returning to step 204 in FIG. 6A. The play station may generate audio and/or visual cues with suggestions for additional bathroom activities that may be performed, e.g., by multiple appropriate buttons in sequence and generating audio cues identifying the respective activities as buttons are illuminated.

If the adult wants to permit the child the option to utilize the real working sink, the adult can open the rear cabinet shown in FIG. 5, ensure the water jugs (one container holding fresh water, the other empty to capture waste water) are sufficiently full/empty and properly positioned underneath the inlet tube of the water pump and the drain tube of the sink. By employing an isolated water system, the invention allows an adult to control the quantity of water available for use by the child (e.g., up to, but not exceeding, one gallon). This ensures the adult maintains control over the amount of water used by the child and that the second jug, without any spillage or overflow, will capture the water that flows down the drain, and this teaches children the importance of conservation.

FIG. 7 is a schematic circuit diagram showing an electronic cueing circuit or system 172 for a toy bathroom play station according to an embodiment of the present invention. The play station includes sensors 174 positioned in the play station to detect the presence of toiletry items in their designated spaces, the position of doors, and the operational state of the faucet and other fixtures. The play station also includes a controller 182 configured to receive output signals from the sensors 174 as well as an audio circuit 184, an indicator light circuit 186, and a timing circuit 188 configured to operate in response to signals from the controller. In an embodiment, the controller and the above associated circuits include electronic and/or computational devices to aid in implementing the functionalities described here. The audio circuit generates audio signals that drive speakers located on the play station. The indicator light circuit selectively powers item-identifying lights on the play station. Power for the play station may be provided by a battery 189 via a master switch that allows parents or guardians to control operation of the play station. In addition to or as an alternative to the battery, the play station may receive external electrical power. The water pump 134 and vanity lighting 150 may also be powered by the battery via separate switches. Preferably the master power switch 180 is located near the top and/or rear of the play station so as to be inaccessible to young children. In an embodiment, a separate switch (not shown) interrupting power to the water pump 134 can optionally be provided in a location accessible only to an adult, for example in the rear interior of the base unit adjacent to the water supply container 130. Such a separate switch allows an adult to permit a child to use the play station without having to supervise the child's use of water.

From the above, it will be appreciated that embodiments of the toy bathroom play station according to the present invention teach and motivate children to practice washing their hands, brushing their teeth, combing their hair, and mastering other bathroom activities conducive to proper personal hygiene using various simulated and/or real toiletry items. The bathroom play station also teaches and motivates children to conserve electricity and/or water through a variety of audible and/or visual cues (e.g., reminders to turn off the lights and/or water in the play station). By teaching conservation habits, the play station also establishes social and environmentally sound habits for the next generation at an unprecedented but critical early age.

The bathroom play station simulates a bathroom vanity environment with fixtures that are of reduced scale in comparison to full-size bathroom fixtures, in order to enable young children standing in front of the play station to reach and operate the various fixtures without adult assistance. The play station preferably includes brackets and/or molded receptacles for the toiletry items to help children locate the designated spaces for the items. To this end, the brackets and/or receptacles are preferably shaped so that only one specific item (e.g., hair brush versus thermometer) fits at each location, teaching children how to identify the various items and making it easier for children to return each item to its proper location after it is used.

The play station may be configured to deliver water through a faucet, e.g., via a water pump that draws water from a refillable container and pumps it to the faucet under pressure. If provided, the water pump is preferably manually-operated or battery-powered, and may optionally have a built-in timer to conserve the battery power and limit the amount of water that is used during a play session. A washable, super absorbent, bath mat may also be provided to help prevent water from puddling on the floor around the play station.

The play station preferably includes a plurality of sensors positioned adjacent movable and/or fixed parts of the play station and coupled with a sound and/or light cueing circuit that is responsive to data received from the various sensors to produce audible messages, sound effects and/or music and/or visual cues to encourage use of the play station and provide positive reinforcement of good habits. The lights, sound, and pump are preferably battery operated and controlled with on/off switches. Any type of suitable sensors may be used, including without limitation photosensors, contact switches, magnetic switches, radio frequency identification tags, and the like.

In an embodiment, there are multiple columns of buttons, each button picturing an item disposed in or on the play station. The buttons are preferably affixed to the front of the unit within easy reach of the child. Once a child presses a button, an audible and/or visual cue is produced, e.g., stating the name of the item pictured on the button and/or illuminating a light adjacent the location of the item, to cause the child to associate the picture on a button with a specific item and its proper location on the play station.

In an embodiment, the use of audible and/or visual cues in a simulated bathroom vanity environment helps achieve one or more of the social goals of this invention—namely to encourage and establish good hygiene habits while increasing speech-language skills in children through pretend play. Additionally, this helps to teach children the importance of conservation and a “greener” environment by allowing for a limited (e.g., approximately one gallon) capacity of water to be used for the real working sink.

In an embodiment, these goals can be further reinforced by providing an optional digital media device, such as an instructional and interactive children's DVD highlighting use of the educational bathroom play station. The digital media device or DVD preferably features a variety of characters (animated, puppets and/or real people) to underscore the features of the bathroom play station in an interactive and entertaining fashion while providing a visual and/or audible demonstration for the child or others using the play station. Content of the digital media device or DVD (music and/or audible/visual instruction and/or video/visual images and/or pictured characters) is preferably also incorporated into features of the bathroom play station. The integration of such content into the play station enhances a child's familiarity with both the subject matter associated of the play station (personal hygiene and conservation) as well as specific play station features.

In an embodiment, the digital media device contains instructions executable by a digital media player to perform an audio visual presentation containing at least some of the same music as the audio circuit. In an embodiment, the educational bathroom play station includes a digital media player mounted on the base or top unit.

In an embodiment, the play station does not have item or fixture identifying lights but may still provide an audio circuit and audio cueing.

In an embodiment, at least some of the flat or planar surfaces of the play station are constructed, at least in part, using a magnetic material that allows the child or adult user to attach a variety of magnetic devices and objects to the magnetic surfaces of the play station. In an embodiment, the magnetic surface is disposed on the top unit around one or more wall cabinets. For example, the play station can be provided with a single centrally located wall cabinet on a center panel of the top unit with a magnetic surface surrounding the wall cabinet and optionally covering a front surface of one or more side panels. In an embodiment, all or a portion of the magnetic surface is covered with a mural or illustration (e.g., a landscape of a pond) which the child can then populate with magnets from a magnet set included with the play station, or sold as an after market item. The magnet set can include child safe magnets shaped as and/or adorned with images of animate or inanimate objects. For example, for a magnetic surface covered with a landscape illustration of a pond, a magnet set could include magnets shaped as, and/or adorned with images of, a frog, turtle, duck, bird and/or other creatures that could be found in such an environment.

In an embodiment, the magnetic wall might be a thin, detachable layer that can be detached or peeled from the unit and replaced by another magnetic strip, that would snugly snap into place surrounding the wall cabinet. In an embodiment, these detachable magnetic strips could have different murals or illustrative landscapes (e.g., under ocean water) which the child could then populate with a different, more environmentally appropriate set of magnets (e.g., fish and underwater sea creatures). Other magnet sets may not be associated with a particular landscape scene (e.g. letter or number magnet sets and/or magnet sets including magnets in the shape of, and/or adorned with images of, toiletry items contained in the bathroom play station).

In an embodiment, other surfaces of the unit, in lieu of or in addition to the upper wall panels, may be magnetic and may offer alternative or additional graphic images that would offer the user additional space to place magnets.

While the invention has been particularly taught and described with reference to certain preferred embodiments, those versed in the art will appreciate that modifications in form and detail may be made without departing from the spirit and scope of the invention. For example, the number, shape and/or location of the item buttons may be changed; the types of items depicted on the buttons and contained within the wall cabinet may be varied; and/or the items may be disposed in a single cabinet or multiple cabinets. The wall structure defining the top unit of the play station preferably includes a plurality of upright wall panels, but may be composed of a single wall panel if desired. Furthermore, the doors to the wall cabinets may be mirrored as shown or non-reflective, and may be hinged or sliding doors. While the bathroom play station is shown with three wall cabinets, the invention can include a single wall cabinet located on a center or one of the side panels, or two or more wall cabinets located on one or more wall panels. In addition, any of the wall cabinets can be covered by single or double doors. While the wall cabinet doors may have illuminated frames, it will be appreciated that single or multiple lights arranged near or on the doors also may be used. In addition, one or more of the base cabinet doors may be illuminated, for example, to direct the child to the location of a trash can, toilet paper or some other supply normally stored in a bathroom cabinet. Similarly, one or more faucet handles may be illuminated, for example to encourage children to wash their hands and/or turn off the water after a predetermined delay. Illumination of doors and items on the vanity top or within the cabinets may be programmed to occur immediately in response to a button being pushed or a door being opened, or may be programmed to occur after a predetermined delay to correspond with a reminder to return an item to its proper location, shut off the faucet, etc. It will also be appreciated that the educational bathroom play station according to the present invention may be provided without item-identifying or fixture-identifying lights, and that interactive features of the invention can instead be provided by audio cues generated by the system in response to removal and/or replacement of toiletry items from their designated spaces, and/or use of play station fixtures. These and other modifications of the present invention are intended to be within the scope of the appended claims.

What is claimed is:

1. An educational play station for teaching bathroom hygiene to children, said play station comprising:
a bathroom vanity ergonomically adapted for use by a child, said bathroom vanity including a base unit with a sink, a top unit above said base unit, and a plurality of designated spaces for toiletry items defined on at least one of said base unit and said top unit;
a plurality of simulated toiletry items disposed in said designated spaces;
a plurality of buttons disposed on said bathroom vanity, said buttons each displaying an icon representative of one of said plurality of toiletry items;
a plurality of item-identifying light sources disposed adjacent said designated spaces; and
a light circuit responsive to operation of at least one of said plurality of buttons to cause at least one of said plurality of item-identifying light sources adjacent a toiletry item to emit light guiding a user to said toiletry item in response to operation of one of said plurality of buttons displaying an icon corresponding to said toiletry item.

2. The educational play station of claim 1, wherein said top unit includes a wall cabinet with a door and a fixture-identifying light source disposed adjacent said door and wherein at least a portion of said designated spaces are disposed within said wall cabinet.

3. The educational play station of claim 2, wherein said light circuit is responsive to operation of one or more of said buttons corresponding to items disposed within said wall cabinet to cause said fixture-identifying light source adjacent said door to emit light in response to operation of said one or more buttons corresponding to items disposed in said wall cabinet.

4. The educational play station of claim 3, further comprising a switch disposed adjacent said wall cabinet door and connected to said light circuit to disable said item-identifying light sources in said wall cabinet when said door is closed and to enable said item-identifying light sources to emit light when said door is open.

5. The educational play station of claim 4, further comprising an audio circuit adapted to play a prerecorded audio cue reminding the user to close the wall cabinet door and a timer circuit, wherein said switch is connected to said audio circuit and said timer circuit to cause said prerecorded audio cue to play when said wall cabinet door is left open for more than a predetermined period of time as measured by said timer circuit.

6. The educational play station of claim 5, further comprising means for choosing the language of the audio cue.

7. The educational play station of claim 1, wherein at least a portion of said designated spaces include receptacles configured to receive toiletry items.

8. The educational play station of claim 7, further comprising a plurality of sensors disposed adjacent said receptacles for determining whether a toiletry item is present in each of said receptacles.

9. The educational play station of claim 8, further comprising an audio circuit adapted to play a prerecorded audio cue reminding the user to return a toiletry item to a receptacle and a timer circuit, wherein said sensor is connected to said audio circuit and said timer circuit to cause said prerecorded audio cue to play when said item is removed from its designated receptacle for more than a predetermined period of time as measured by said timer circuit.

10. The educational play station of claim 9, wherein said light circuit is configured to cause said item-identifying light source adjacent said receptacle to flash in conjunction with said prerecorded audio cue to guide the user to the designated receptacle.

11. The educational play station of claim 7, wherein said toiletry items disposed in said wall cabinet each have a unique shape and wherein said receptacles conform in shape to a corresponding toiletry item.

12. The educational play station of claim 1, further comprising a plurality of icons displayed on said vanity adjacent said designated spaces, wherein each of said icons corresponds to one of said plurality of toiletry items.

13. The educational play station of claim 12, wherein said icons displayed on said vanity adjacent said designated spaces are the same as said icons displayed on said buttons.

14. The educational play station of claim 1, further comprising a power source and a power switch connected between said power source and said light circuit, wherein said power switch is disposed at a location on said vanity that is substantially inaccessible to children, for disconnecting the power source.

15. The educational play station of claim 1, wherein said light circuit is configured to cause a sequence of light sources to emit light in response to operation of one of said plurality of buttons.

16. The educational play station of claim 15, further comprising a cabinet with a door, wherein at least some of said toiletry items are disposed in said cabinet, and wherein said light circuit, in response to operation of a button displaying an icon corresponding to an item disposed in said cabinet, first causes a fixture-identifying light source adjacent said door to emit light and then, when said door is open, causes an item-identifying light source adjacent a toiletry item in said cabinet to emit light.

17. The educational play station of claim 1, wherein said vanity includes one or more control surfaces oriented to face a user and wherein said plurality of buttons are disposed on said one or more control surfaces.

18. The educational play station of claim 17, wherein said vanity includes a pair of control surfaces on opposite sides of said sink, and wherein said buttons are disposed on the control surface corresponding to the side of the vanity on which the corresponding items are disposed.

19. The educational play station of claim 1, further comprising a motion sensor oriented to detect the presence of a user in front of said vanity and an audio circuit with a prerecorded audio cue welcoming a user with instructions for use in response to a signal from said motion sensor indicating that a user is present.

20. The educational play station of claim 19, further comprising button-identifying light sources disposed adjacent at least some of said buttons and wherein said light circuit is connected to said motion sensor to cause said button-identifying light sources to emit light in conjunction with said prerecorded audio cue.

21. The educational play station of claim 1, further comprising water supply means for supplying water to said sink and drain means for collecting water dispensed into said sink.

22. The educational play station of claim 21, wherein said water supply means includes a faucet, a water jug and a pump in fluid communication with said faucet and said water jug.

23. The educational play station of claim 22, wherein said drain means includes a drain formed in said sink and a water jug in fluid communication with said drain.

24. The educational play station of claim 22, wherein said faucet includes flow control means and a fixture-identifying light source disposed adjacent said flow control means.

25. The educational play station of claim 24, further comprising a button with an icon representing an act involving use of said sink, and wherein said light circuit is adapted to cause said fixture-identifying light source adjacent said flow control means to emit light in response to operation of said button.

26. The educational play station of claim 25, wherein said light circuit is further adapted to cause an item-identifying light source adjacent a toiletry item to emit light in association with said fixture-identifying light source adjacent said faucet.

27. The educational play station of claim 26, further comprising one or more real toiletry items.

28. The educational play station of claim 27, wherein said one or more real toiletry items includes at least one of a soap dispenser, a soap dish, a toothbrush, a hair brush, and a comb.

29. The educational play station of claim 22, further comprising an automated flow control means and a timing circuit, wherein said automated flow control means is adapted to stop the flow of water through said faucet after a pre-determined period of time as measured by said timing circuit.

30. The educational play station of claim 23, further comprising a partition disposed within said vanity to define a water compartment and a door providing access to said water compartment, and wherein said jugs are disposed within said water compartment.

31. The educational play station of claim 1, further comprising an operational scale attached to said vanity for measuring at least one of weight and height.

32. The educational play station of claim 31, wherein said scale includes a platform for measuring weight and wherein said platform is movable between a deployed position extending from said vanity and a folded position against said vanity.

33. The educational play station of claim 1, further comprising a simulated scale for measuring at least one of weight and height and a fixture-identifying light source disposed adjacent said scale.

34. The educational play station of claim 33, further comprising a button having an icon corresponding to an act involving use of a scale, and wherein said fixture-identifying light source is responsive to operation of said button to cause light to be emitted so as to guide a user to said scale.

35. The educational play station of claim 33, further comprising an audio circuit with a prerecorded audio cue instructing a user how to use the scale in response to operation of one of said plurality of buttons.

36. The educational play station of claim 31, further comprising a memory device for storing information about at least one of a user's weight and height, and means for conveying stored information to a user.

37. The educational play station of claim 33, wherein said scale includes a platform for measuring weight and wherein said platform is movable between a deployed position extending from said vanity and a folded position against said vanity.

38. An educational play station for teaching bathroom hygiene to children, said play station comprising:
a bathroom vanity ergonomically adapted for use by a child, said bathroom vanity including a base unit with a sink, a top unit, and a plurality of designated spaces for toiletry items on at least one of said base unit and said top unit;
a plurality of simulated toiletry items disposed in said designated spaces;
a plurality of buttons disposed on said bathroom vanity, said buttons each displaying an icon representative of one of said plurality of toiletry items;
one or more item-identifying indicators associated with said plurality of toiletry items; and
a circuit responsive to operation of at least one of said plurality of buttons to cause said one or more item-identifying indicators to provide at least one of an audible cue and a visual cue guiding a user to said toiletry item in response to operation of one of said plurality of buttons displaying an icon corresponding to said toiletry item.

39. The educational play station of claim 38, wherein at least one of said one or more item-identifying indicators includes an item-identifying light source disposed adjacent one of said plurality of designated spaces to provide a visible cue guiding a user to one of said toiletry items.

40. The educational play station of claim 38, wherein at least one of said one or more item-identifying indicators includes an item-identifying audio cue guiding the user to one of said toiletry items.

41. The educational play station of claim 38, wherein said bathroom vanity includes one or more bathroom fixtures and further comprising one or more fixture-identifying indicators associated with said one or more bathroom fixtures.

42. The educational play station of claim 41, wherein said circuit is configured to cause at least one item-identifying indicator and at least one fixture-identifying indicator to be actuated in response to operation of one of said plurality of buttons.

43. The educational play station of claim 38, wherein said one or more bathroom fixtures includes at least one of a magazine rack, a towel holder, a hook, a drawer, a trash can and a hamper.

44. The educational play station of claim 1, further comprising an audio circuit adapted to play music in response to operation of one of said plurality of buttons.

45. The educational play station of claim 44, further comprising a digital media device containing instructions executable by a digital media player to perform an audio visual presentation containing at least some of the same music as said audio circuit.

46. The educational play station of claim 45, wherein said audio visual presentation includes at least one depiction of an activity associated with bathroom hygiene.

47. An educational play station for teaching bathroom hygiene to children, said play station comprising:
a bathroom vanity ergonomically adapted for use by a child, said bathroom vanity including a base unit with a sink and a top unit disposed on said base unit;
at least one bathroom fixture associated with one of said base unit and said top unit;
a plurality of removable simulated toiletry items disposed on at least one of said base unit and said top unit;
a plurality of buttons disposed on said bathroom vanity, at least some of said buttons displaying an icon representative of one of a bathroom activity involving one of said plurality of toiletry items and one of said plurality of toiletry items;
one or more indicators associated with at least one of said bathroom fixture and one of said toiletry items; and
a circuit responsive to operation of at least one of said plurality of buttons to cause said one or more indicators to provide at least one of an audible and a visual cue guiding a user to at least one of said bathroom fixture and said toiletry item in response to operation of one of said plurality of buttons.

48. The educational play station of claim 47, wherein said at least one bathroom fixture includes a faucet and wherein at least one of said plurality of buttons displays an icon representative of a bathroom activity involving use of a faucet.

49. The educational play station of claim 48, wherein said bathroom activity is one of washing hands and brushing teeth.

50. The educational play station of claim 48, wherein said one or more indicators includes a visible indicator located adjacent said faucet.

51. The educational play station of claim 47, wherein at least a portion of said plurality of removable toiletry items are non-working simulated toiletry items.

52. The educational play station of claim 51, wherein said non-working simulated toiletry items are substantially the same size and shape as real toiletry items.

53. The educational play station of claim 47, wherein said simulated toiletry items include at least one of a razor, a nail clipper, toothpaste, mouthwash, moisturizer, deodorant, bandages and a thermometer.

54. The educational play station of claim 47, further comprising a power source and a power switch connected between said power source and said circuit, wherein said power switch is disposed at a location on said bathroom vanity that is substantially inaccessible to children, for disconnecting the power source.

55. The educational play station of claim 47, further comprising a power source and an audio control switch connected to said power source and said circuit to enable and disable the audio cues.

56. The educational play station of claim 47, further comprising a vanity light on said top unit, a power source, and a light switch connected to said vanity light and said power source, said light switch being ergonomically located on one of said base and top units for operation by a child to turn said vanity light on and off.

57. The educational play station of claim 56, wherein said circuit is adapted to play an audio cue reminding the user to turn the light off after a predetermined period of time.

58. The educational play station of claim 56, wherein said circuit is adapted to automatically disable power to said vanity light after a predetermined period of time.

59. The educational play station of claim 47, further comprising a mirrored surface on at least one of said top and base units.

60. The educational play station of claim 59, further comprising a door hingedly mounted on at least one of said top and base units, and wherein said mirrored surface is disposed on said door.

61. The educational play station of claim 47, further comprising an absorbent mat configured to be positionable in relation to said vanity so that a portion of said mat lays in front of said vanity.

62. The educational play station of claim 61, wherein said mat includes a first portion configured to lay underneath said vanity and a second portion that lays in front of said vanity.

63. The educational play station of claim 62, wherein said mat includes a depiction of a pair of footprints on said second portion of said mat to guide a user into a proper position to access said toiletry items and fixtures.

64. A method of teaching hygiene to a child using a bathroom play station including a vanity and a plurality of toiletry items disposed in designated spaces on the vanity, said method comprising the steps of:
presenting the child with a plurality of buttons arranged on the vanity at locations remote from the designated spaces, at least some of the buttons including icons associated with toiletry items included as part of the bathroom play station; and
guiding the child to the designated space for a toiletry item by actuating an item-identifying light source adjacent the designated space in response to operation of a button with an icon associated with the toiletry item associated with the space.

65. The method of claim 64, wherein at least some of the toiletry items are contained within a wall cabinet with a door and wherein said guiding step includes actuating a light associated with the door when a button corresponding to an item in the wall cabinet is selected.

66. The method of claim 64, wherein at least some of the toiletry items are contained within a wall cabinet with a door and further comprising the step of actuating an audible cue including an instruction to open the door when a button corresponding to an item in the wall cabinet is selected.

67. The method of claim 64, wherein at least some of the toiletry items are contained within a wall cabinet with a door and further comprising the step of actuating an audible cue including a reminder to close the door after a predetermined period of time after the door is opened.

68. The method of claim 64, wherein at least some of the toiletry items are contained within a wall cabinet with a door and further comprising the step of sensing removal of a toiletry item from a designated space in the wall cabinet and actuating an audible cue in response to said sensing step.

69. The method of claim 68, wherein said step of actuating an audible cue includes an instruction how to use the toiletry item removed from the wall cabinet.

70. The method of claim 68, wherein said step of actuating an audible cue includes a reminder to return the item removed from the wall cabinet if the door is closed before the item is returned.

71. The method of claim 64, further comprising the step of sensing removal of an item from its designated space and actuating an audible cue in response to said sensing step.

72. The method of claim 71, wherein said audible cue includes an instruction how to use the toiletry item removed from its designated space.

73. The method of claim 71, wherein said audible cue includes a reminder to return the item to its designated space after a predetermined period of time.

74. The method of claim 64, wherein at least one of the buttons on the educational play station depicts a bathroom activity involving at least one toiletry item and further comprising the step of actuating a light source associated with the at least one toiletry item and at least one light source associated with a bathroom fixture of the educational play station.

75. The method of claim 74, wherein the bathroom fixture includes at least one of a faucet, a cabinet door, and a towel rack.

76. The method of claim 75, wherein the faucet is a simulated faucet and further comprising the step of actuating an audio cue of running water when the user pretends to use the simulated faucet.

77. The method of claim 64, wherein the educational play station includes a working faucet with at least one control member movable between open and closed positions and further comprising the steps of sensing the position of the control member and actuating an audio cue including a reminder to turn the faucet off when the control member is left in the open position for a predetermined period of time.

78. The method of claim 77, further comprising the step of pumping water through the faucet when the control member is in the open position.

79. The method of claim 78, wherein the water is pumped through the faucet from a container disposed within a locked compartment in the educational play station and further comprising the step of collecting water from the faucet in a container disposed within a locked compartment.

80. The method of claim 64, further comprising the step of sensing the presence of a user within a predetermined distance of the educational play station and actuating an audio cue in response to said sensing step.

81. The method of claim 80, wherein the audio cue includes at least one of a greeting, an invitation to perform a hygienic activity involving at least one toiletry item contained in a designated space, and an invitation to use a bathroom fixture of the educational play station.

82. The method of claim 64, wherein the bathroom fixture includes at least one of a weight scale and height scale.

83. The method of claim 82, further comprising the step of storing at least one of a weight and a height of a user.

84. The method of claim 82, further comprising the step of actuating an audio cue including information about a change in at least one of height and weight of the user since a last measurement.

85. A method of teaching hygiene to a child using a bathroom play station including a vanity, said method comprising the steps of:
presenting the child with a plurality of simulated toiletry items disposed in designated spaces on the vanity, wherein the designated spaces are configured to accommodate actual toiletry items and the simulated toiletry items are substantially the same shape and size as the actual toiletry items; and
replacing at least some of the simulated toiletry items with corresponding actual toiletry items in the appropriate designated spaces.

86. The method of claim 85, wherein the replacing step occurs after the child has learned the location and use of at least some of the simulated toiletry items.

87. The method of claim 85, wherein said presenting step includes placing at least some of the simulated toiletry items in receptacles on the vanity configured to receive the actual toiletry items.

88. The method of claim 85, further comprising the step of displaying icons on the vanity adjacent at least some of the designated spaces, wherein the icons represent at least some of the toiletry items.
